(19) United States
(12) Patent Application Publication
(10) Pub. No.: US 2009/0324147 A1
(43) Pub. Date: Dec. 31, 2009

(54) THIN LIQUID FILM FOR A SPINDLE MOTOR GAS BEARING SURFACE

(76) Inventors: Raquib U. Khan, Pleasanton, CA (US); Michael J. Stirniman, Fremont, CA (US)

Correspondence Address: SEAGATE TECHNOLOGY LLC;C/O NOVAK DRUCE & QUIGG LLP, 1000 LOUISIANA, Fifty-Third Floor, HOUSTON, TX, 77002, US

(21) Appl. No.: 12/147,451

(22) Filed: Jun. 26, 2008

(51) Int. Cl. F16C 32/06

(52) U.S. Cl. 384/100; 384/107

(57) ABSTRACT

A system and method are provided for reduced power consumption and reduced wear in a spindle motor. The spindle motor includes a fluid dynamic bearing containing gas defined between a stationary component and a rotatable component. A liquid layer is coated on at least a portion of at least one of the rotatable component surface and the stationary component surface. The liquid layer is formed from a liquid having a predetermined concentration, and formed having a predetermined thickness. The predetermined thickness is accomplished utilizing at least one of a predetermined dwell time, withdraw velocity and bearing surface roughness. In an aspect, the liquid layer is formed with an increased thickness by at least one of increasing the liquid concentration, increasing the dwell time, and increasing the withdraw velocity. In an aspect, a method is provided to obtain thin liquid film thicknesses ranging from about 5 nm to about 350 nm.

### BACKGROUND

Disc drive memory systems store digital information that is recorded on concentric tracks of a magnetic disc medium. At least one disc is rotatably mounted on a spindle, and the information, which can be stored in the form of magnetic transitions within the discs, is accessed using read/write heads or transducers. A drive controller is conventionally used for controlling the disc drive system based on commands received from a host system. The drive controller controls the disc drive to store and retrieve information from the magnetic discs. The read/write heads are located on a pivoting arm that moves radially over the surface of the disc. The discs are rotated at high speeds during operation using an electric motor located inside a hub or below the discs. One type of motor has a spindle mounted by means of a bearing system to a motor shaft disposed in the center of the hub. The bearings permit rotational movement between the shaft and a sleeve, while maintaining alignment of the spindle to the shaft. Because rotational accuracy is critical, recent disc drives utilize a motor having fluid dynamic bearings (FDB) between the shaft and sleeve to support a hub and the disc for rotation. In a hydrodynamic bearing, a lubricating fluid such as gas or liquid provides a bearing surface between a fixed member and a rotating member of the disc drive.

Disc drive memory systems are being utilized in progressively more environments besides traditional stationary computing environments. Recently, disc drive memory systems are incorporated into devices that are operated in digital cameras, digital video cameras, video game consoles, personal music players, in addition to portable computers. As such, performance and design needs have intensified.

Storage density has increased, and the size of the storage system has decreased. This trend has lead to greater precision and lower tolerance in the manufacturing and operating of magnetic storage discs. For example, to achieve increased storage densities the transducing head must be placed increasingly close to the surface of the storage disc. This proximity requires that the disc rotate substantially in a single plane. A slight wobble or run-out in disc rotation can cause the surface of the disc to contact the transducing head. This is known as a “crash” and can damage the transducing head and surface of the storage disc resulting in loss of data. Thus, the bearing assembly which supports the storage disc is of critical importance.

Because the two surfaces which form the gap of the hydrodynamic bearing are not mechanically separated, the potential for surface impact exists. Such impacts could occur when the motor supported by the bearing is at rest, or even more damaging, when a shock to the system occurs while the motor is either stopped or spinning. Over time, such impacts could wear down a region on one of the bearing surfaces, altering the pressure distribution and reducing bearing efficiency or induce catastrophic failure due to surface damage like galling. Moreover, particles could be generated by the scraping of one side against the other, which particles would continue to be carried about by the fluid. Such particles could build up over time, scraping the surfaces which define the hydrodynamic bearing, or being expelled into the region surrounding the motor where they could easily damage the disc recording surface.

Additionally, because of the trend for high speed applications in the disc drive industry, power is also a significant factor for optimized performance. A fluid bearing may consume 20% to 30% of the total power of a disc drive, depending on the type of drive. Although the fluid bearing (utilizing a liquid) is robust, at low temperatures and higher speeds, the liquid bearing consumes significant power. Gas bearings are typically utilized for lower power consumption, but conventional gas bearings are especially vulnerable to wear and impact during start-up and stop, as compared to liquid bearings. The gas bearing gap is typically in the range of 0.5 to 5 microns, whereas the liquid bearing has a larger gap with greater tolerance.

### SUMMARY

The present invention provides a system and method for reduced power consumption and reduced wear in a spindle motor. The spindle motor includes a fluid dynamic bearing containing gas defined between a stationary component and a rotatable component. A liquid layer is coated on at least a portion of at least one of the rotatable component surface and the stationary component surface. The liquid layer is formed from a liquid having a predetermined concentration, and formed having a predetermined thickness. The predetermined thickness is accomplished utilizing at least one of a predetermined dwell time, withdraw velocity and bearing surface roughness. These and various other features and advantages will be apparent from a reading of the following detailed description.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a top plan view of a disc drive data storage system in which the present invention is useful, in accordance with an embodiment of the present invention;

FIG. 2 is a sectional side view of a hydrodynamic bearing spindle motor used in a disc drive data storage system, in which the present invention is useful;

FIG. 3 is a sectional view of a portion of the hydrodynamic bearing spindle motor as in FIG. 2, taken perpendicular to a centerline axis length of the shaft, illustrating a thin liquid layer coated on the shaft, in accordance with an embodiment of the present invention;

FIG. 4 is a sectional side view of another hydrodynamic bearing spindle motor, illustrating a thin liquid layer coated on the shaft and thrustplate, in accordance with an embodiment of the present invention;

FIG. 5 is a graphical illustration of a liquid layer thickness study utilizing various withdraw speeds, in accordance with an embodiment of the present invention; and

FIG. 6 is a graphical illustration of another liquid layer thickness study utilizing various liquid concentrations, dwell times and withdraw speeds, in accordance with an embodiment of the present invention.

### DETAILED DESCRIPTION

Exemplary embodiments are described with reference to specific configurations. Those of ordinary skill in the art will appreciate that various changes and modifications can be made while remaining within the scope of the appended claims. Additionally, well-known elements, devices, components, methods, process steps and the like may not be set forth in detail in order to avoid obscuring the invention.

A system and method are described herein for providing reduced power consumption and reduced wear in a spindle motor. The spindle motor includes a fluid dynamic bearing containing gas defined between a stationary component and a rotatable component. A liquid layer is coated on at least a portion of at least one of the rotatable component surface and the stationary component surface, for resisting wear resistance to these surfaces. The liquid layer is formed from a liquid having a predetermined concentration, and formed having a predetermined thickness. The predetermined thickness is accomplished utilizing at least one of a predetermined dwell time, withdraw velocity and bearing surface roughness, as described below. The present invention improves bearing performance. As compared to fluid bearings, the gas bearing of the present invention reduces power consumption. The liquid layer can last for the life of the disc drive, has a low surface energy, high temperature resistance, and has a tendency to spread over the surface even after numerous bearing surface touch downs.

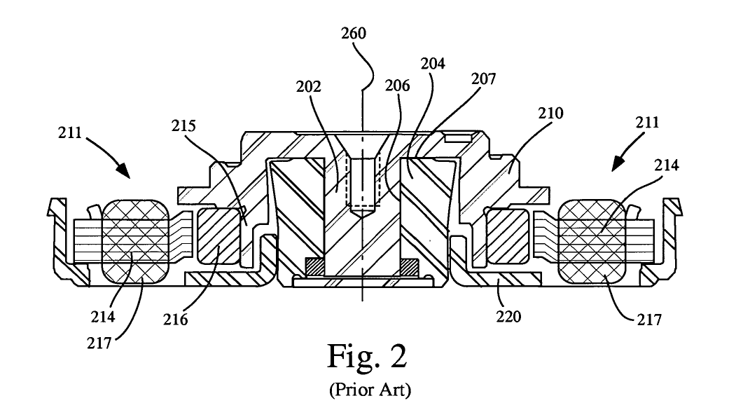

It will be apparent that features of the discussion and claims may be utilized with disc drives, low profile disc drive memory systems, spindle motors, various fluid dynamic bearing design motors including hydrodynamic and hydrostatic motors, and other motors employing a stationary and a rotatable component, including motors employing conical bearings. Further, embodiments of the present invention may be employed with a fixed shaft or a rotating shaft. Also, as used herein, the terms “axially” or “axial direction” refers to a direction along a centerline axis length of the shaft (i.e., along axis 260 of shaft 202 shown in FIG. 2), and “radially” or “radial direction” refers to a direction perpendicular to the centerline length of the shaft 202. Also, as used herein, the expressions indicating orientation such as “upper”, “lower”, “top”, “bottom” and the like, are applied in a sense related to normal viewing of the figures rather than in any sense of orientation during particular operation, etc. These orientation labels are provided simply to facilitate and aid understanding of the figures and are not to be construed as limiting.

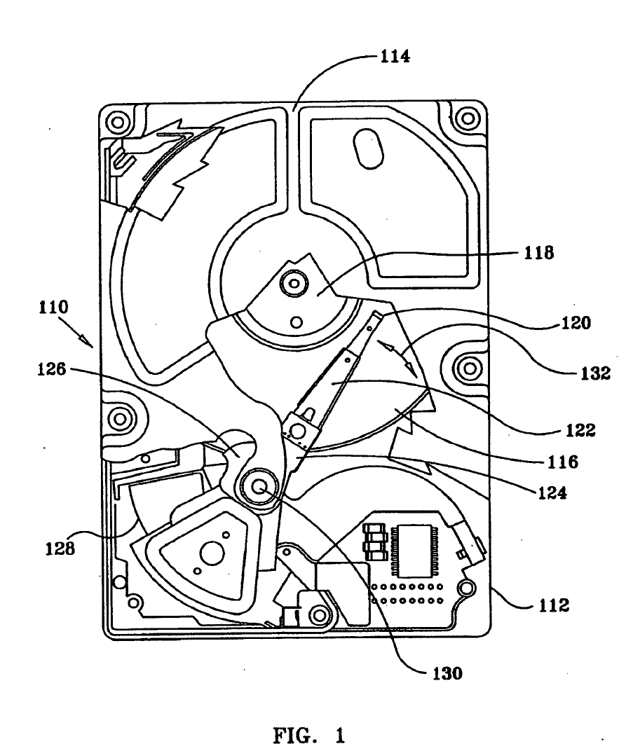

Referring to the drawings wherein identical reference numerals denote the same elements throughout the various views, FIG. 1 illustrates a top plan view of a disc drive data storage system 110 in which the present invention is useful. Clearly, features of the discussion and claims are not limited to this particular design, which is shown only for purposes of the example. Disc drive 110 includes base plate 112 that is combined with cover 114 forming a sealed environment to protect the internal components from contamination by elements outside the sealed environment. Disc drive 110 further includes disc pack 116, which is mounted for rotation on a spindle motor (described in FIG. 2) by disc clamp 118. Disc pack 116 includes a plurality of individual discs, which are mounted for co-rotation about a central axis. Each disc surface has an associated head 120 (read head and write head), which is mounted to disc drive 110 for communicating with the disc surface. In the example shown in FIG. 1, heads 120 are supported by flexures 122, which are in turn attached to head mounting arms 124 of actuator body 126. The actuator shown in FIG. 1 is a rotary moving coil actuator and includes a voice coil motor, shown generally at 128. Voice coil motor 128 rotates actuator body 126 with its attached heads 120 about pivot shaft 130 to position heads 120 over a desired data track along arc path 132. This allows heads 120 to read and write magnetically encoded information on the surfaces of discs 116 at selected locations.

A flex assembly provides the requisite electrical connection paths for the actuator assembly while allowing pivotal movement of the actuator body 126 during operation. The flex assembly (not shown) terminates at a flex bracket for communication to a printed circuit board mounted to the bottom side of disc drive 110 to which head wires are connected; the head wires being routed along the actuator arms 124 and the flexures 122 to the heads 120. The printed circuit board typically includes circuitry for controlling the write currents applied to the heads 120 during a write operation and a preamplifier for amplifying read signals generated by the heads 120 during a read operation.

Referring to FIG. 2, a sectional side view is illustrated of a hydrodynamic bearing spindle motor, as used in a disc drive data storage system 110 as in FIG. 1. The motor includes stationary components that are relatively rotatable with rotatable components, defining a journal bearing 206 therebetween. In this example, the rotatable components include shaft 202 and hub 210. Hub 210 includes a disc flange, which supports disc pack 116 (shown in FIG. 1) for rotation about axis 260 of shaft 202. Shaft 202 and hub 210 are integral with backiron 215. One or more magnets 216 are attached to a periphery of backiron 215. The magnets 216 interact with a lamination stack 214 attached to the base 220 to cause the hub 210 to rotate. Magnet 216 can be formed as a unitary, annular ring or can be formed of a plurality of individual magnets that are spaced about the periphery of hub 210. Magnet 216 is magnetized to form one or more magnetic poles. The stationary components include sleeve 204 and stator 211 (stator comprising lamination stack 214 and stator windings 217), which are affixed to base plate 220. Bearing 206 is established between the sleeve 204 and the rotating shaft 202. A thrust bearing 207 is established between hub 210 and sleeve 204. Thrust bearing 207 provides an upward force on hub 210 to counterbalance the downward forces including the weight of hub 210, axial forces between magnet 216 and base plate 220, and axial forces between stator lamination stack 214 and magnet 216. In the case of a fluid dynamic bearing spindle motor, a gas fills the interfacial regions between shaft 202 and sleeve 204, and between hub 210 and sleeve 204, as well as between other stationary and rotatable components.

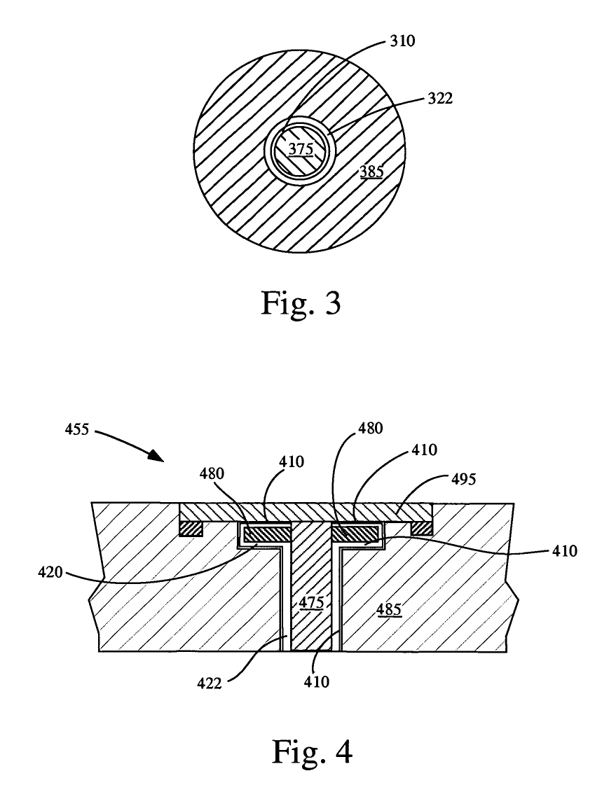

FIG. 3 shows a sectional view of a portion of a hydrodynamic bearing spindle motor, taken perpendicular to centerline axis 260 of shaft 202 as shown in FIG. 2. The spindle motor includes a gas bearing 322 defined between a shaft 375 and a sleeve 385. The gas bearing gap of FIG. 3 is enlarged and emphasized for illustrative purposes, bearing gaps in many cases being in the range of several microns. A thin liquid layer 310 is coated on at least a portion of the shaft 375, for wear resistance to each facing bearing surface, in accordance with an embodiment of the present invention. Alternatively, the thin liquid layer 310 may be coated on at least a portion of the sleeve 385, or coated on both the shaft 375 and sleeve 385. The thin liquid layer 310 is also enlarged and emphasized for illustrative purposes.

The liquid layer 310 is formed from a liquid having a predetermined concentration, and formed having a predetermined thickness. The predetermined thickness is accomplished utilizing at least one of a predetermined dwell time, withdraw velocity and bearing surface roughness. The predetermined dwell time is the time that either the rotatable component surface or the stationary component surface is situated within the liquid prior to being withdrawn from the liquid. The withdraw velocity is the velocity at which either the rotatable component surface or the stationary component surface is withdrawn from the liquid. The bearing surface roughness is the roughness of either the rotatable component surface or the stationary component surface.

The liquid layer can be formed from a variety of substances. Example substances include PFPE, functional PFPE, phosphazene, phosphate ester, a mixture of PFPE and an additive selected from the group consisting of phosphate ester, triaryl phosphate, trialkyl phosphates, TCP and butylated triphenyl phosphate. Example PFPE substances that can be used by the present invention include Z-Tetraol and Z-Dol (by Solvay Solexis™). The liquid concentration can be diluted if needed, for example utilizing PF5060 (by 3M™), and Vertrel XF. The liquid layer is applied to the bearing surface using either dipping, spraying or wiping. In one example, the bearing surface roughness is established in the range of 10 to 100 nm. The thin liquid layer may be coated to a variety of bearing surfaces, including steel, bronze, DLC, Al₂O₃, TiC, SiN, SiC, and TiN. The liquid layer can be either bonded or not bonded to the bearing surface. The liquid layer is applied prior to operation of the spindle motor, although the liquid layer may have a tendency to spread over the surface after the bearing is put into operation. The thin liquid layer may be utilized along with a wear resistant carbon coating such as diamond-like coating (DLC). Further, the present invention thin liquid layer may eliminate the need for the use of DLC on the relatively rotatable fluid bearing surfaces.

In an embodiment, the predetermined liquid used to form the liquid layer has a concentration in the range of 0.25% to 5%, and the liquid layer is formed with an increased thickness by at least one of: increasing the liquid concentration, increasing the dwell time, and increasing the withdraw velocity. In an embodiment, the withdraw velocity utilized is at least about 0.5 mm/sec. to achieve a substantially uniform liquid layer thickness. It is to be appreciated that the selection of the liquid layer thickness is dependent on factors including bearing size, bearing surface finish, and bearing operational rotation speed. Also, the hardness of the surface material may be considered. In one example, the surface material utilized is a hardened 440C, with a Rockwell scale Rc, in the range of 58 to 60.

Methods of achieving various liquid layer thicknesses are provided by the present invention. In one example, the predetermined liquid is Z-Tetraol, the predetermined concentration is 1%, the predetermined dwell time is in the range of 5 to 10 seconds, the predetermined withdraw velocity is 4 mm/sec., and the liquid layer predetermined thickness is in the range of 20 nm to 110 nm. In another example, the predetermined liquid is Z-Tetraol, the predetermined concentration is 2%, the predetermined dwell time is in the range of 5 to 10 seconds, the predetermined withdraw velocity is 4 mm/sec., and the liquid layer predetermined thickness is in the range of 60 nm to 125 nm. The liquid layer thickness may even more generally range from about 40 nm to 150 nm. In yet another example, the predetermined liquid is Z-Tetraol, the predetermined concentration is 3.33%, the predetermined dwell time is in the range of 5 to 10 seconds, the predetermined withdraw velocity is in the range of 4 mm/sec. to 6 mm/sec., and the liquid layer predetermined thickness is in the range of 80 nm to 195 nm. The liquid layer thickness may even more generally range from about 60 nm to 225 nm. In yet a further example, the predetermined liquid is Z-Tetraol, the predetermined concentration is 5%, the predetermined dwell time is in the range of 5 to 10 seconds, the predetermined withdraw velocity is 4 mm/sec., and the liquid layer predetermined thickness is in the range of 225 nm to 260 nm. The liquid layer thickness may even more generally range from about 120 nm to 350 nm.

As illustrated in FIG. 4, a sectional side view of a hydrodynamic bearing spindle motor 455 is shown having a thrustplate 480 and counterplate 495. The bearing gap 422 is enlarged and emphasized for illustrative purposes, bearing gaps in many cases being in the range of several microns. A fluid gap 420 (also emphasized) also exists between adjacent surfaces of counterplate 495 and thrustplate 480. Further, a fluid gap 420 exists between adjacent surfaces of thrust plate 480 and sleeve 485. Wherever a gap exists, a potential for adjacent facing surface adhesive and abrasive wear exists. The present invention thin liquid coating resists wear to these surfaces. The thin liquid coating of the present invention also minimizes or prevents any effects that contact stop/start (CSS) might have on bearing surfaces. That is, when the head 120 (FIG. 1) is in contact with the disk, the bearing surfaces are similarly in contact, for example, adjacent surfaces of shaft 475 and sleeve 485.

To preserve the bearing, a suitable pair of components having adjacent surfaces (a surface and a counter surface) are selected for a thin liquid coating. For example, any one of or all of shaft 475, sleeve 485, thrustplate 480, and counterplate 495 may be selected for a thin liquid coating. As shown in FIG. 4, sleeve 485 and counterplate 495 (or portions of sleeve 485 and counterplate 495) include a liquid layer 410. In an alternative embodiment, shaft 475 and thrustplate 480 (or portions of shaft 475 and thrustplate 480) include a liquid film.

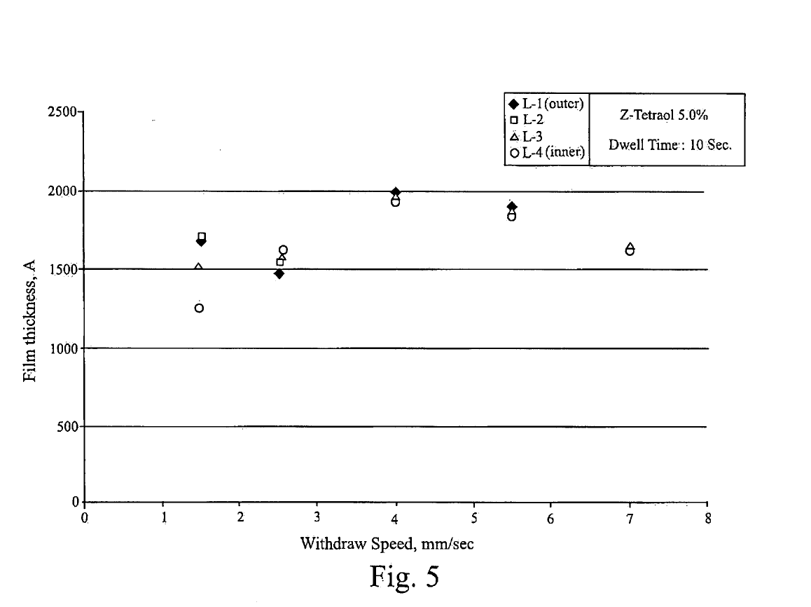

Turning now to FIG. 5, a graphical illustration of a liquid layer thickness study is shown utilizing various withdraw speeds. Cone shafts, which can be employed in a disc drive, were dipped in Z-Tetraol, at 5.0% concentration, with a 10 sec. dwell time, and withdrawn at the indicated speeds. Four measurements were taken, from an axial center to an axial end of the shaft (inner to outer, notated as L-1, L-2, L-3, L-4). The resulting liquid layer thicknesses are illustrated (in Angstroms). It was discovered that by utilizing withdraw speeds above about 0.5 mm/sec., the film thicknesses are substantially constant, from the axial center to the axial end of the shaft. In an embodiment of the present invention, the withdraw velocity utilized is at least about 0.5 mm/sec. to achieve a substantially uniform liquid layer thickness.

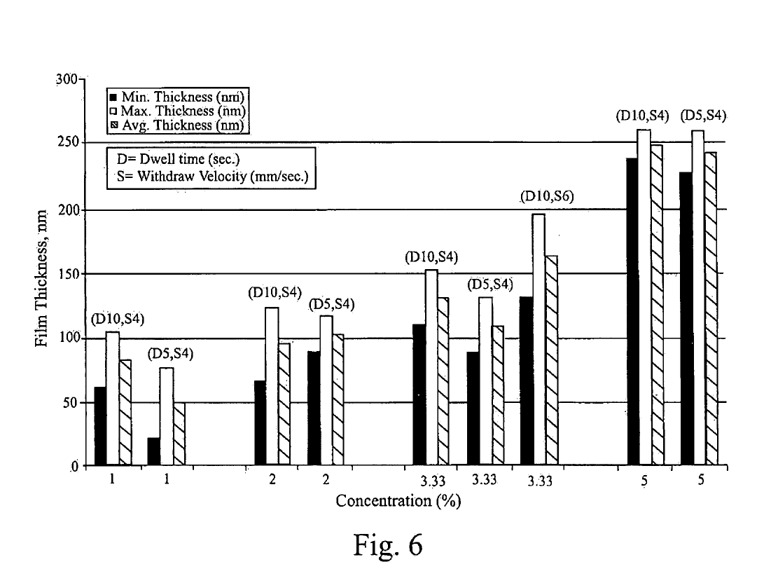

Referring to FIG. 6, a graphical illustration of another liquid layer thickness study is illustrated utilizing various liquid concentrations, dwell times (indicated as “D”) and withdraw velocities (indicated as “S”). It was discovered that the higher concentration of 5.0% Z-Tetraol provides the greater liquid layer thickness, and that the liquid layer thickness decreases incrementally as the concentration of Z-Tetraol is reduced down to 0.25%. Further, it was discovered that increasing the dwell time from 5 sec. to 10 sec. slightly increases the liquid layer thickness. In the case of Z-Tetraol having a concentration of 3.33%, an increased withdraw velocity from 4 mm/sec. to 6 mm/sec. results in an increased liquid layer thickness. From this study, a desired thin liquid layer film thickness can be obtained. This study provides a method of obtaining thin liquid film thicknesses ranging from about 20 nm to about 260 nm, for bearing surfaces of relatively rotating components, as may be utilized in a spindle motor and disc drive system.

Modifications and variations may be made to the disclosed embodiments while remaining within the spirit and scope of the invention. The implementations described above and other implementations are within the scope of the following claims.

We claim:

1. A spindle motor comprising:
a fluid dynamic bearing containing gas defined between a stationary component and a rotatable component, wherein the stationary component and the rotatable component are positioned for relative rotation;
a rotatable component surface that faces a stationary component surface; and
a liquid layer, coating at least a portion of at least one of the rotatable component surface and the stationary component surface, for resisting wear to the at least one of the rotatable component surface and the stationary component surface, wherein the liquid layer is formed from a predetermined liquid having a predetermined concentration, and wherein the liquid layer is formed having a predetermined thickness by at least one of:
i) utilizing a predetermined dwell time that the one of the rotatable component surface and the stationary component surface is situated within the predetermined liquid prior to being withdrawn;
ii) withdrawing one of the rotatable component surface and the stationary component surface at a predetermined velocity from the predetermined liquid; and
iii) employing a roughness on one of the rotatable component surface and the stationary component surface.

2. The spindle motor as in claim 1, wherein the predetermined liquid has a concentration in the range of 0.25% to 5%, and wherein the liquid layer is formed with an increased thickness by at least one of: increasing the liquid concentration, increasing the dwell time, and increasing the withdraw velocity.

3. The spindle motor as in claim 1, wherein, one of:
(i) the predetermined liquid is Z-Tetraol, the predetermined concentration is 1%, the predetermined dwell time is in the range of 5 to 10 seconds, the predetermined withdraw velocity is 4 mm/sec., and the liquid layer predetermined thickness is in the range of 20 nm to 110 nm;
(ii) the predetermined liquid is Z-Tetraol, the predetermined concentration is 2%, the predetermined dwell time is in the range of 5 to 10 seconds, the predetermined withdraw velocity is 4 mm/sec., and the liquid layer predetermined thickness is in the range of 40 nm to 150 nm;
(iii) the predetermined liquid is Z-Tetraol, the predetermined concentration is 3.33%, the predetermined dwell time is in the range of 5 to 10 seconds, the predetermined withdraw velocity is in the range of 4 mm/sec. to 6 mm/sec., and the liquid layer predetermined thickness is in the range of 60 nm to 225 nm; and
(iv) the predetermined liquid is Z-Tetraol, the predetermined concentration is 5%, the predetermined dwell time is in the range of 5 to 10 seconds, the predetermined withdraw velocity is 4 mm/sec., and the liquid layer predetermined thickness is in the range of 120 nm to 350 nm.

4. The spindle motor as in claim 1, wherein the withdraw velocity utilized is at least about 0.5 mm/sec. to achieve a substantially uniform liquid layer thickness.

5. The spindle motor as in claim 1, wherein the roughness of one of the rotatable component surface and the stationary component surface is in the range of 10 nm to 100 nm.

6. The spindle motor as in claim 1, wherein the liquid layer is bonded to the at least a portion of at least one of the rotatable component surface and the stationary component surface.

7. The spindle motor as in claim 1, wherein the liquid layer is applied to the at least a portion of at least one of the rotatable component surface and the stationary component surface, using one of dipping, spraying and wiping.

8. The spindle motor as in claim 1, wherein the liquid concentration is formed by dilution utilizing PF5060 (by 3M™), and Vertrel XF.

9. The spindle motor as in claim 1, wherein the liquid layer is comprised of one of PFPE, functional PFPE, Z-Tetraol, Z-Dol (by Solvay Solexis™), phosphazene, phosphate ester, and a mixture of PFPE and an additive selected from the group consisting of phosphate ester, triaryl phosphate, trialkyl phosphates, TCP and butylated triphenyl phosphate.

10. The spindle motor as in claim 1, wherein the liquid layer is coated on at least a portion of at least one of a thrustplate and a counterplate.

11. The spindle motor as in claim 1, wherein the stationary component is a shaft and the rotatable component is a sleeve.

12. In a spindle motor including: a fluid dynamic bearing containing gas defined between a stationary component and a rotatable component, wherein the stationary component and the rotatable component are positioned for relative rotation; a rotatable component surface that faces a stationary component surface; and a liquid layer, coating at least a portion of at least one of the rotatable component surface and the stationary component surface, for resisting wear to the at least one of the rotatable component surface and the stationary component surface, a method comprising:
forming the liquid layer from a predetermined liquid having a predetermined concentration, and forming the liquid layer having a predetermined thickness by at least one of:
i) utilizing a predetermined dwell time that the one of the rotatable component surface and the stationary component surface is situated within the predetermined liquid prior to being withdrawn;
ii) withdrawing one of the rotatable component surface and the stationary component surface at a predetermined velocity from the predetermined liquid; and
iii) employing a roughness on one of the rotatable component surface and the stationary component surface.

13. The method as in claim 12, further comprising increasing the liquid layer thickness by at least one of: increasing the liquid concentration, increasing the dwell time, and increasing the withdraw velocity, wherein the predetermined liquid has a concentration in the range of 0.25% to 5%.

14. The method as in claim 12, further comprising one of:
(i) forming the liquid layer thickness in the range of 20 nm to 110 nm by: utilizing Z-Tetraol for the predetermined liquid, 1% concentration for the predetermined concentration, the range of 5 to 10 seconds for the predetermined dwell time, and 4 mm/sec. for the predetermined withdraw velocity;
(ii) forming the liquid layer thickness in the range of 40 nm to 150 nm by: utilizing Z-Tetraol for the predetermined liquid, 2% concentration for the predetermined concentration, the range of 5 to 10 seconds for the predetermined dwell time, and 4 mm/sec. for the predetermined withdraw velocity;
(iii) forming the liquid layer thickness in the range of 60 nm to 225 nm by: utilizing Z-Tetraol for the predetermined liquid, 3.33% concentration for the predetermined concentration, the range of 5 to 10 seconds for the predetermined dwell time, and 4 mm/sec. to 6 mm/sec. for the predetermined withdraw velocity; and
(iv) forming the liquid layer thickness in the range of 120 nm to 350 nm by: utilizing Z-Tetraol for the predetermined liquid, 5% concentration for the predetermined concentration, the range of 5 to 10 seconds for the predetermined dwell time, and 4 mm/sec. for the predetermined withdraw velocity.

15. The method as in claim 12, further comprising utilizing at least about 0.5 mm/sec. for the withdraw velocity, to achieve a substantially uniform liquid layer thickness.

16. The method as in claim 12, further comprising utilizing a roughness in the range of 10 nm to 100 nm for one of the rotatable component surface and the stationary component surface.

17. The method as in claim 12, further comprising bonding the liquid layer to the at least a portion of at least one of the rotatable component surface and the stationary component surface.

18. The method as in claim 12, further comprising applying the liquid layer to the at least a portion of at least one of the rotatable component surface and the stationary component surface, using one of dipping, spraying and wiping.

19. The method as in claim 12, wherein the liquid layer is comprised of one of PFPE, functional PFPE, Z-Tetraol, Z-Dol (by Solvay Solexis™), phosphazene, phosphate ester, and a mixture of PFPE and an additive selected from the group consisting of phosphate ester, triaryl phosphate, trialkyl phosphates, TCP and butylated triphenyl phosphate.

20. The method as in claim 12, further comprising coating the liquid layer on at least a portion of at least one of a thrustplate, a counterplate, a shaft, and a sleeve.
